(19) United States
(12) Patent Application Publication
(10) Pub. No.: US 2024/0222693 A1
(43) Pub. Date: Jul. 4, 2024

(54) POSITIVE ELECTRODE LAYER, POSITIVE ELECTRODE, AND SOLID-STATE BATTERY

(71) Applicants: Toru KIDOSAKI, Miyoshi-shi (JP); Tomoyuki OKUYAMA, Utsunomiya-Shi (JP)

(72) Inventors: Toru KIDOSAKI, Miyoshi-shi (JP); Tomoyuki OKUYAMA, Utsunomiya-Shi (JP)

(73) Assignees: TOYOTA JIDOSHA KABUSHIKI KAISHA, Toyota-Shi (JP); Idemitsu Kosan Co., Ltd., Tokyo (JP)

(21) Appl. No.: 18/394,652

(22) Filed: Dec. 22, 2023

(30) Foreign Application Priority Data
Dec. 27, 2022 (JP) 2022-210342

(51) Int. Cl. H01M 10/0562

(52) U.S. Cl. CPC H01M 10/0562; H01M 2300/008; H01M 2300/0082

(57) ABSTRACT

A positive electrode layer contains a sulfide solid electrolyte containing a lithium atom, a sulfur atom and a halogen atom. The sulfide solid electrolyte has, on a surface thereof, a covering layer containing at least one type selected from compounds expressed by following general formula (1), compounds expressed by following general formula (2), polymers of compounds expressed by following general formula (1), polymers of compounds expressed by following general formula (2), and polymers of a compound expressed by following general formula (1) and a compound expressed by following general formula (2).

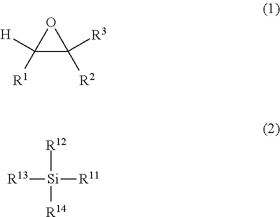

### CROSS-REFERENCE TO RELATED APPLICATION

This application is based on and claims priority under 35 USC 119 from Japanese Patent Application No. 2022-210342 filed on Dec. 27, 2022, the disclosure of which is incorporated by reference herein.

### BACKGROUND

### Technical Field

The present disclosure relates to a positive electrode layer, a positive electrode, and a solid-state battery.

### Related Art

Accompanying the rapid popularization of information-related devices, communication devices and the like such as personal computers, video cameras, cell phones and the like in recent years, the development of batteries that are used as the power sources thereof is regarded as important. Thereamong, attention is focusing on lithium ion batteries from the standpoints that such batteries have high energy density and excellent stability.

Conventionally, electrolyte liquids containing organic solvents that are flammable have been used in batteries utilized for such applications. Therefore, there is the need for improvement in structures and materials for preventing short-circuiting and for mounting safety devices that suppress a rise in temperature at the time of a short circuit. To address this, batteries that use a solid electrolyte layer instead of an electrolyte liquid are being developed because, by solidifying batteries by replacing electrolyte liquids with solid electrolytes, simplification of safety devices is achieved due to not using a flammable organic solvent within the battery, and the manufacturing cost and mass producibility are excellent.

Patent Document 1 discloses, as a solid electrolyte that is contained in a solid electrolyte layer, a modified sulfide solid electrolyte containing: a sulfide solid electrolyte whose BET specific surface area is greater than or equal to 10 m²/g, and that contains a lithium atom, a sulfur atom, a phosphorous atom and a halogen atom; and an epoxy compound, wherein the infrared absorption spectrum obtained by FT-IR analysis (ATR method) has a peak within 2800˜3000 cm¹.

### PRIOR ART DOCUMENTS

### Patent Documents

Patent Document 1: International Publication (WO) No. 2022/158458

### SUMMARY

In solid-state batteries, there is a tendency for the resistance to increase due to repeated charging/discharging. An increase in the resistance increase rate means that the deterioration of the battery caused by charging/discharging of the battery increases.

Here, the present inventors found that, if the modified sulfide solid electrolyte disclosed in Patent Document 1 is contained in a negative electrode layer or a solid electrolyte layer, there is a concern that the resistance rate will become even higher, and that, even if the modified sulfide solid electrolyte disclosed in Patent Document 1 is contained in a positive electrode layer, there is a concern that the resistance increase rate will become even higher.

Embodiments of the present disclosure have been made in view of the above-described circumstances, and a problem that the present disclosure solves is to provide a positive electrode layer that can reduce the resistance increase rate of a solid-state battery, a positive electrode having the positive electrode layer, and a solid-state battery having the positive electrode.

Means for addressing the above-described topic include the following aspects. A positive electrode layer of a first aspect includes a sulfide solid electrolyte containing a lithium atom, a sulfur atom and a halogen atom,
wherein the sulfide solid electrolyte has, on a surface thereof, a covering layer containing at least one type selected from compounds expressed by following general formula (1), compounds expressed by following general formula (2), polymers of compounds expressed by following general formula (1), polymers of compounds expressed by following general formula (2), and polymers of a compound expressed by following general formula (1) and a compound expressed by following general formula (2).

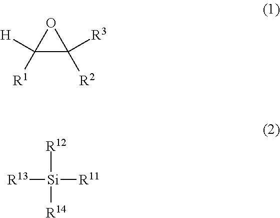

(In formula (1), R¹˜R³ are each independently a hydrogen atom, a halogen atom, a monovalent hydrocarbon group or a monovalent halogenated hydrocarbon group, at least one of R¹˜R³ is a monovalent hydrocarbon group or a monovalent halogenated hydrocarbon group, and at least one of R¹˜R³ has an ether structure.

In formula (2), R¹¹˜R¹⁴ are each independently a hydrogen atom, a halogen atom, a monovalent silyl ether group, a monovalent hydrocarbon group or a monovalent halogenated hydrocarbon group, and at least one of R¹¹˜R¹⁴ is a silyl ether group.) A positive electrode layer of a second aspect is the positive electrode layer of the first aspect, wherein the covering layer contains at least one of a compound expressed by general formula (1) and a polymer of a compound expressed by general formula (1), and any two among R¹˜R³ are hydrogen atoms, and one is a monovalent hydrocarbon group having an ether structure.

A positive electrode layer of a third aspect is the positive electrode layer of the first aspect or the second aspect, wherein the covering layer contains at least one of a compound expressed by general formula (2) and a polymer of a compound expressed by general formula (2), and among R¹¹˜R⁴, three are monovalent silyl ether groups, and one is a monovalent hydrocarbon group.

A positive electrode layer of a fourth aspect is the positive electrode layer of any one of the first aspect through the third aspect, wherein the covering layer contains at least one type selected from compounds expressed by a following chemical formula, and polymers containing at least one compound expressed by the following chemical formula.

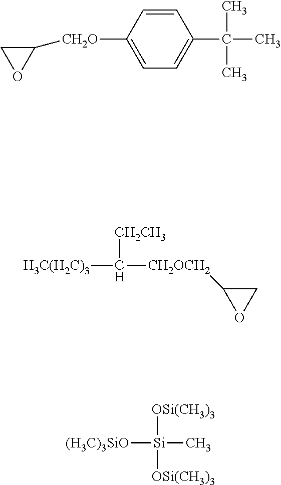

A positive electrode layer of a fifth aspect is the positive electrode layer of any one of the first aspect through the fourth aspect, wherein a molecular weight or weight average molecular weight of a compound expressed by general formula (1), a compound expressed by general formula (2), a polymer of a compound expressed by general formula (1), a polymer of a compound expressed by general formula (2), and a polymer of a compound expressed by general formula (1) and a compound expressed by general formula (2) is 60 or more.

A positive electrode layer of a sixth aspect is the positive electrode layer of any one of the first aspect through the fifth aspect, wherein, given that a content of the sulfide solid electrolyte contained in the positive electrode layer is 100 parts by mass, a sum of contents of a compound expressed by general formula (1), a compound expressed by general formula (2), a polymer of a compound expressed by general formula (1), a polymer of a compound expressed by general formula (2), and a polymer of a compound expressed by general formula (1) and a compound expressed by general formula (2) is 0.1 parts by mass ˜20 parts by mass.

A positive electrode of a seventh aspect includes a positive electrode collector and the positive electrode layer of any one of the first aspect through the sixth aspect.

A solid-state battery of an eighth aspect includes the positive electrode of the seventh aspect, an electrolyte layer, and a negative electrode having a negative electrode layer and a negative electrode collector.

A solid-state battery of a ninth aspect is the solid-state battery of the eighth aspect, wherein the electrolyte layer does not contain a solid electrolyte having, on a surface, a covering layer that contains at least one type selected from among compounds expressed by following general formula (1), compounds expressed by following general formula (2), polymers of compounds expressed by following general formula (1), polymers of compounds expressed by following general formula (2), and polymers of a compound expressed by following general formula (1) and a compound expressed by following general formula (2), or the electrolyte layer contains a solid electrolyte having the covering layer, and a content of the solid electrolyte having the covering layer, with respect to a total mass of the electrolyte layer, is less than or equal to 1 mass %, and the negative electrode layer does not contain a solid electrolyte having, on a surface, a covering layer that contains at least one type selected from among compounds expressed by following general formula (1), compounds expressed by following general formula (2), polymers of compounds expressed by following general formula (1), polymers of compounds expressed by following general formula (2), and polymers of a compound expressed by following general formula (1) and a compound expressed by following general formula (2), or the negative electrode layer contains a solid electrolyte having the covering layer, and a content of the solid electrolyte having the covering layer, with respect to a total mass of the negative electrode layer, is less than or equal to 1 mass %.

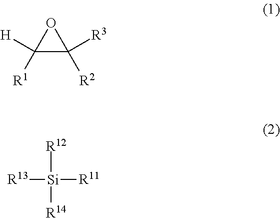

(In formula (1), R¹˜R³ are each independently a hydrogen atom, a halogen atom, a monovalent hydrocarbon group or a monovalent halogenated hydrocarbon group, at least one of R¹˜R³ is a monovalent hydrocarbon group or a monovalent halogenated hydrocarbon group, and at least one of R¹˜R³ has an ether structure.

In formula (2), R¹¹˜R¹⁴ are each independently a hydrogen atom, a halogen atom, a monovalent silyl ether group, a monovalent hydrocarbon group or a monovalent halogenated hydrocarbon group, and at least one of R¹¹˜R¹⁴ is a silyl ether group.)

According to the embodiments of the present disclosure, there can be provided a positive electrode layer that can reduce the resistance increase rate of a solid-state battery, a positive electrode having the positive electrode layer, and a solid-state battery having the positive electrode.

### BRIEF DESCRIPTION OF THE DRAWINGS

FIG. 1 is a schematic sectional view illustrating an embodiment of a solid electrolyte of the present disclosure.

### DETAILED DESCRIPTION

In the present disclosure, numerical ranges expressed by using “˜” mean ranges in which the numerical values listed before and after the “˜” are included as the minimum value and maximum value, respectively.

In numerical value ranges that are expressed in a stepwise manner in the present disclosure, the upper limit value or the lower limit value listed in a given numerical value range may be substituted by the upper limit value or the lower limit value of another numerical value range that is expressed in a stepwise manner. In the numerical value ranges put forth in the present disclosure, the upper limit value or the lower limit value listed in a given numerical value range may be substituted by a value set forth in the Examples.

In the present disclosure, combinations of two or more preferable aspects are more preferable aspects.

In the present disclosure, in a case in which there are plural types of materials that correspond to a component, the amount of that component means the total amount of the plural types of materials, unless otherwise indicated.

In the present disclosure, “solid electrolyte” means an electrolyte that maintains a solid state at 25° C. in a nitrogen atmosphere.

In the present embodiment, “sulfide solid electrolyte” includes both crystalline sulfide solid electrolytes having a crystal structure and non-crystalline sulfide solid electrolytes.

In the present disclosure, a crystalline sulfide solid electrolyte is a solid electrolyte in which a peak originated in the solid electrolyte is observed in an X-ray diffraction pattern in powder X-ray diffraction (XRD) measurement, while the absence/presence of a peak originated in the raw material of the solid electrolyte therein does not matter. Namely, crystalline sulfide solid electrolytes include crystal structures that derive from the solid electrolyte, and a portion thereof may be a crystal structure derived from the solid electrolyte, or the entirety thereof may be a crystal structure derived from the solid electrolyte. Further, provided that it has an X-ray diffraction pattern such as described above, a portion of the crystalline sulfide solid electrolyte may contain a non-crystalline sulfide solid electrolyte (also called a “glass component”). Accordingly, crystalline sulfide solid electrolytes include so-called glass ceramics that are obtained by heating a non-crystalline solid electrolyte (a glass component) to the crystallization temperature or higher.

Further, in the present disclosure, a non-crystalline sulfide solid electrolyte (glass component) means a material in which, in powder X-ray diffraction (XRD) measurement, the X-ray diffraction pattern is a hollow pattern in which substantially no peaks other than the peak originated in the material are observed, while the absence/presence of peaks originated in the raw material of the solid electrolyte does not matter.

### [Positive Electrode Layer]

The positive electrode layer of the present disclosure contains a sulfide solid electrolyte (hereinafter also called “specific sulfide solid electrolyte”) containing a lithium atom, a sulfur atom and a halogen atom, wherein the sulfide solid electrolyte has, on the surface thereof, a covering layer containing at least one type selected from compounds expressed by following general formula (1), compounds expressed by following general formula (2) (hereinafter, the compounds expressed by following general formula (1) and the compounds expressed by following general formula (2) are also called “specific compounds”), polymers of compounds expressed by following general formula (1), polymers of compounds expressed by following general formula (2), and polymers of a compound expressed by following general formula (1) and a compound expressed by following general formula (2) (hereinafter, polymers of compounds expressed by following general formula (1), polymers of compounds expressed by following general formula (2), and polymers of a compound expressed by following general formula (1) and a compound expressed by following general formula (2) are also called “specific polymers”).

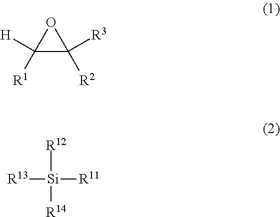

In formula (1), R¹˜R³ are each independently a hydrogen atom, a halogen atom, a monovalent hydrocarbon group or a monovalent halogenated hydrocarbon group, at least one of R¹˜R³ is a monovalent hydrocarbon group or a monovalent halogenated hydrocarbon group, and at least one of R¹˜R³ has an ether structure.

In formula (2), R¹¹˜R¹⁴ are each independently a hydrogen atom, a halogen atom, a monovalent silyl ether group, a monovalent hydrocarbon group or a monovalent halogenated hydrocarbon group, and at least one of R¹¹˜R¹¹ is a silyl ether group.

According to the positive electrode layer of the present disclosure, the resistance increase rate of a solid-state battery can be reduced. Reasons for this effect are unclear, but are surmised to be as follows.

In a sulfide solid electrolyte that does not have a covering layer, at times of charging/discharging, electrons are drawn away by carbon fibers and the like, and the sulfide solid electrolyte deteriorates. It is thought that, due to the sulfide solid electrolyte having a covering layer, such deterioration can be suppressed, and the resistance increase rate of the solid-state battery can be reduced.

Further, oxygen is emitted from the deteriorated sulfide solid electrolyte and reacts with the sulfide solid electrolyte, which leads to further deterioration. However, it is thought that, due to the sulfide solid electrolyte having a covering layer, reaction with oxygen can be suppressed, and the resistance increase rate of the solid-state battery can be reduced.

Moreover, there are cases in which the positive electrode layer contains a conduction assistant. It is thought that, in such a case, reaction of the conduction assistant and the sulfide solid electrolyte can be suppressed, and the resistance increase rate of the solid-state battery can be reduced.

### (Sulfide Solid Electrolyte)

The sulfide solid electrolyte contains a lithium atom, a sulfur atom and a halogen atom.

The sulfide solid electrolyte may be non-crystalline or may be crystalline.

In one embodiment, the composition of the sulfide solid electrolyte is expressed by, for example, xLi₂S·(100-x)P₂S₅ (70≤x≤80), yLiI·zLiBr·(100-y-z)(xLi₂S·(1-x)P₂S₅) (0.7≤x≤0.8, 0≤y≤30, 0≤z≤30), or the like.

Further, the sulfide solid electrolyte may have the composition expressed by following general formula [1].

$${Li}_{4 - x} {Ge}_{1 - x} {P}_{x} {S}_{4} ( 0 < x < 1 ) \qquad formula [ 1 ]$$

In formula [1], at least some of the Ge may be substituted by at least one selected from the group consisting of Sb, Si, Sn, B, Al, Ga, In, Ti, Zr, V and Nb. Further, at least some of the P may be substituted by at least one selected from the group consisting of Sb, Si, Sn, B, Al, Ga, In, Ti, Zr, V and Nb. Some of the Li may be substituted by at least one selected from the group consisting of Na, K, Mg, Ca and Zn. Some of the S may be substituted by a halogen. The halogen is at least one of F, Cl, Br and I.

Examples of the non-crystalline sulfide solid electrolyte are: solid electrolytes structured from lithium sulfide, phosphorus sulfide, and lithium halides such as Li₂S—P₂S₅—LiI, Li₂S—P₂S₅—LiCl, Li₂S—P₂S₅—LiBr, Li₂S—P₂S₅—LiI—LiBr and the like; solid electrolytes further containing another atom such as an oxygen atom, a silicon atom or the like such as Li₂S—P₂S₅—Li₂O—LiI, Li₂S—SiS₂—P₂S₅—LiI, and the like; and the like.

From the standpoint of obtaining even higher ion conductivity, preferable examples are solid electrolytes structured from lithium sulfide, phosphorus sulfide and lithium halides such as Li₂S—P₂S₅—LiI, Li₂S—P₂S₅—LiCl, Li₂S—P₂S₅—LiBr, Li₂S—P₂S₅—LiI—LiBr and the like.

The types of the atoms that structure the non-crystalline sulfide solid electrolyte can be confirmed by, for example, an ICP emission spectrophotometer.

The crystalline sulfide solid electrolyte may be a so-called glass ceramic that is obtained by heating a non-crystalline solid electrolyte to the crystallization temperature or higher.

Examples of the crystal structure thereof are Li₃PS₄ crystal structure, Li₄P₂S₆ crystal structure, Li₇PS₆ crystal structure, Li₇P₃S₁₁ crystal structure, crystal structures having peaks in the vicinity of 2θ=20.2° and in the vicinity of 23.6° (e.g., Japanese Patent Application Laid-Open (JP-A) No. 2013-16423) and the like. Further, examples are Li₄₋ₓGe₁₋ₓPₓS₄ thio-LISICON Region II type crystal structures (refer to Kanno et al., Journal of The Electrochemical Society, 148(7) A742-746 (2001)), crystal structures (refer to Solid State Ionics, 177(2006), 2721-2725) that are similar to Li₄₋ₓGe₁₋ₓPₓS₄ thio-LISICON Region II type crystal structures, and the like.

The shape of the sulfide solid electrolyte is not particularly limited, and includes particle-shaped for example. The average particle diameter (D₅₀) of the sulfide solid electrolyte that is particle-shaped is within ranges of, for example, 0.01 μm˜500 μm, and 0.1˜200 μm.

The content of the sulfide solid electrolyte with respect to the total mass of the positive electrode layer is preferably 10 mass %˜50 mass %, and more preferably 11 mass % 20 mass %.

### —Covering Layer—

The specific sulfide solid electrolyte has a covering layer containing at least one type selected from the specific compounds and the specific polymers. The covering layer may be provided on the entire surface of the specific sulfide solid electrolyte or may be provided on a portion thereof.

Compounds expressed by general formula (1) that is one type of the specific compounds are described hereinafter.

Examples of the halogen atom are fluorine, chlorine, bromine, iodine and the like. Fluorine, chlorine and bromine are preferable, and fluorine is more preferable.

From the standpoint of decreasing the resistance increase rate of the solid-state battery, the monovalent hydrocarbon group preferably has a carbon number of 1˜20, and more preferably has a carbon number of 3˜15, and even more preferably has a carbon number of 5˜10.

The monovalent hydrocarbon group may be any of an aliphatic hydrocarbon group, an alicyclic hydrocarbon group and an aromatic hydrocarbon group, and is preferably an aliphatic hydrocarbon group or an alicyclic hydrocarbon group, and is even more preferably an aliphatic hydrocarbon group. The aliphatic hydrocarbon group may be straight chain or may be branched chain, and is preferably branched chain.

Examples of the aliphatic hydrocarbon group are alkyl group, alkenyl group and the like, and alkyl group is preferable.

Examples of the alicyclic hydrocarbon group are cycloalkyl group, cycloalkenyl group and the like.

Examples of the aromatic hydrocarbon group are phenyl group, naphthyl group, biphenyl group, diphenylmethyl group, trityl group, anthranil group, perylenyl group, pyrenyl group and the like.

A portion of the aromatic hydrocarbon group may be substituted with a hydroxyl group, the above-described monovalent aliphatic hydrocarbon group (e.g., alkyl group, alkenyl group), or the like. For example, benzyl group and the like are also included in the aromatic hydrocarbon group in the present disclosure.

The monovalent hydrocarbon group may contain an ether structure.

Examples of the monovalent halogenated hydrocarbon group are groups in which a portion of the above-described monovalent hydrocarbon group is substituted with a halogen atom. As the halogen atom, fluorine, chlorine and bromine are preferable, and fluorine is more preferable.

From the standpoint of reducing the resistance increase rate of the solid-state battery, it is preferable that, in general formula (1), any two among R¹˜R³ are hydrogen atoms and one is a monovalent hydrocarbon group having an ether structure or a monovalent halogenated hydrocarbon group, and it is more preferable that any two among R¹˜R³ are hydrogen atoms and one is a monovalent hydrocarbon group having an ether structure.

The following compounds are examples of compounds satisfying general formula (1). Note that the compounds that satisfy general formula (1) are not limited to these.

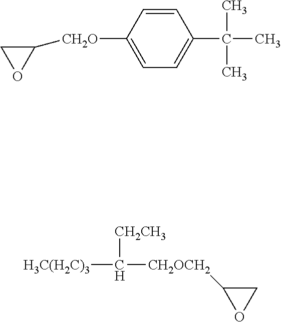

The covering layer may contain a polymer of a compound expressed by general formula (1).

Polymers of compounds expressed by general formula (1) may be structured from only a compound expressed by general formula (1), or may be a polymer that is copolymerized with another monomer or the like, within a scope that does not markedly deteriorate effects of the present disclosure.

Note that, in the present disclosure, polymers of compounds expressed by general formula (1) mean compounds in which two or more of the compound expressed by general formula (1) are polymerized.

Further, the existence of a polymer of a compound expressed by general formula (1) in the covering layer is confirmed by GC-MS.

Compounds expressed by expressed by general formula (2) that is one type of the specific compounds are described hereinafter. Note that, because the halogen atom, the monovalent hydrocarbon group and the monovalent halogenated hydrocarbon group are the same as those of general formula (1), description thereof is omitted here.

The monovalent silyl ether group is preferably a group expressed by *—O—Si—(R²⁰)₃. In this group, R²⁰ are each independently a hydrogen atom or a monovalent hydrocarbon group, and at least one among R²⁰ is a monovalent hydrocarbon group. R²⁰ are preferably monovalent hydrocarbon groups, and aliphatic hydrocarbon groups or alicyclic hydrocarbon groups are preferable, and aliphatic hydrocarbon groups are more preferable. The aliphatic hydrocarbon group may be straight chain or may be branched chain, and is preferably branched chain. The monovalent hydrocarbon group here as well is similar to that of general formula (1), and therefore, description thereof is omitted here.

Further, in the aforementioned group, the * represents a bonding portion with Si in general formula (2).

From the standpoint of reducing the resistance increase rate of the solid-state battery, in general formula (2), it is preferable that at least two of R¹¹˜R¹⁴ are monovalent silyl ether groups, and it is more preferable that at least three are monovalent silyl ether groups, and it is even more preferable that three are monovalent silyl ether groups and one is a monovalent hydrocarbon group.

The following compounds are examples of compounds satisfying general formula (2). Note that compounds that satisfy general formula (2) are not limited to these.

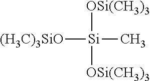

The covering layer may contain a polymer of a compound expressed by general formula (2).

Polymers of compounds expressed by general formula (2) may be structured from only a compound expressed by general formula (2), or may be a polymer that is copolymerized with another monomer or the like, within a scope that does not markedly deteriorate effects of the present disclosure.

Note that, in the present disclosure, polymers of compounds expressed by general formula (2) mean compounds in which two or more of the compounds expressed by general formula (2) are polymerized.

The covering layer may contain a polymer of a compound expressed by general formula (1) and a compound expressed by general formula (2).

This polymer may be structured only from a compound expressed by general formula (1) and a compound expressed by general formula (2), or may be a polymer that is copolymerized with another monomer or the like, within a scope that does not markedly deteriorate effects of the present disclosure.

Note that, in the present disclosure, a polymer of a compound expressed by general formula (1) and a compound expressed by general formula (2) means a compound in which one or more of each of a compound expressed by general formula (1) and a compound expressed by general formula (2) are polymerized.

Further, the existence of a polymer of a compound expressed by general formula (2), and of a polymer of a compound expressed by general formula (1) and a compound expressed by general formula (2), in the covering layer is confirmed by GC-MS.

From the standpoint of decreasing the resistance increase rate of the solid-state battery, the molecular weight of the specific compound is preferably 60 or more, and is more preferably 60˜10,000, and is even more preferably 300˜5000.

The positive electrode layer may contain a specific polymer. In this case, the weight average molecular weight of the specific polymer is preferably 60˜10,000, and is even more preferably 300˜5000.

Note that the “weight average molecular weight” is determined by polystyrene conversion by using gel permeation chromatography (GPC).

If the content of the sulfide solid electrolyte contained in the positive electrode layer is considered to be 100 parts by mass, from the standpoint of reducing the resistance increase rate of the solid-state battery, the sum of the contents of the specific compound and the specific polymer is preferably 0.1 parts by mass ˜20 parts by mass, and more preferably 1 part by mass ˜10 parts by mass, and even more preferably 3 parts by mass ˜7 parts by mass.

From the standpoint of reducing the resistance increase rate of the solid-state battery, the sum of the contents of the specific compound and the specific polymer with respect to the total mass of the positive electrode layer is preferably 0.01 mass %˜4 mass %, and more preferably 0.1 mass %˜2 mass %.

The specific sulfide solid electrolyte that has a covering layer on the surface of a sulfide solid electrolyte can be manufactured by mixing a sulfide solid electrolyte, a specific compound and an organic solvent together, and then removing the organic solvent. Examples of the organic solvent are hexane, pentane, 2-ethylhexane, toluene, dimethylether, diethylether, tert-butylmethylether, dimethoxymethane, dimethoxyethane, methyl acetate, ethyl acetate, propyl acetate, isopropyl acetate, methyl propionate, ethylene diamine, diamino propane, dimethyl ethylene diamine, diethyl ethylene diamine and the like.

A sulfide solid electrolyte that has been manufactured by a conventionally known method or a commercially-available sulfide solid electrolyte may be used as the sulfide solid electrolyte.

### (Positive Electrode Active Material)

The positive electrode layer of the present disclosure may contain a positive electrode active material.

The positive electrode active material is not particularly limited provided that, in relation with the negative electrode active material, it can promote a battery chemical reaction that is accompanied by the movement of lithium ions originating from the atoms that are employed as the atoms that bring ion conductivity, preferably lithium atoms. Examples of such positive electrode active materials at which introduction and breaking-away of lithium ions are possible are oxide positive electrode active materials, sulfide positive electrode active materials, and the like.

Preferable examples of the oxide positive electrode active materials are lithium-containing transition metal composite oxides such as LMO (lithium manganese oxide), LCO (lithium cobalt oxide), NMC (lithium nickel manganese cobalt oxide), NCA (lithium nickel cobalt aluminum oxide), LNCO (lithium nickel cobalt oxide), olivine type compounds (LiMeNPO₄, Me=Fe, Co, Ni, Mn), and the like.

Examples of the sulfide positive electrode active materials include titanium sulfide (TiS₂), molybdenum sulfide (MoS₂), iron sulfide (FeS, FeS₂), copper sulfide (CuS), nickel sulfide (Ni₃S₂) and the like. Further, other than the above-described positive electrode active materials, niobium selenide (NbSe₃) and the like also can be used.

A single type of positive electrode active material can be used alone, or plural types can be used in combination.

The positive electrode active material may have a crystal structure belonging to at least one space group selected from space groups R-3m, Immm, and P63-mmc (also called P₆₃mc, P₆/mmc). Further, in the positive electrode active material, the main sequence of a transition metal, oxygen and lithium may be an O2-type structure.

Examples of positive electrode active materials having a crystal structure belonging to R-3m are compounds expressed by LiₓMe_{y}O_{α}X_{β} (Me represents at least one type selected from the group consisting of Mn, Co, Ni, Fe, Al, Cu, V, Nb, Mo, Ti, Cr, Zr, Zn, Na, K, Ca, Mg, Pt, Au, Ag, Ru, W, B, Si and P, and X represents at least one type selected from the group consisting of F, Cl, N, S, Br and I, and 0.5≤x≤1.5, 0.5≤y≤1.0, 1≤α≤2, 0≤β≤1 are satisfied).

Examples of positive electrode active materials having a crystal structure belonging to Immm are composite oxides expressed by Liₓ₁M¹A¹₂ (1.5≤x1≤2.3 is satisfied, M¹ includes at least one type selected from the group consisting of Ni, Co, Mn, Cu and Fe, A¹ includes at least oxygen, and the ratio of the oxygen contained in A¹ is greater than or equal to 85 atom %) (a specific example is Li₂NiO₂), and composite oxides expressed by Liₓ₁M^{1A}₁₋ₓ₂M^{1B}ₓ₂O_{2-y}A²_{y} (0≤x2≤0.5 and 0≤y≤0.3, at least one of x2 and y is not 0, MiA represents at least one type selected from the group consisting of Ni, Co, Mn, Cu and Fe, M^{1B} represents at least one type selected from the group consisting of Al, Mg, Sc, Ti, Cr, V, Zn, Ga, Zr, Mo, Nb, Ta and W, and A2 represents at least one type selected from the group consisting of F, Cl, Br, S and P).

Examples of positive electrode active materials having a crystal structure belonging to P₆₃-mmc are composite oxides expressed by M1ₓM2_{y}O₂ (M1 represents an alkali metal (at least one of Na and K is preferable), M2 represents a transition metal (at least one type selected from the group consisting of Mn, Ni, Co and Fe is preferable), and x+y satisfies 0≤x+y≤2).

Examples of positive electrode active materials having an O2-type structure are composite oxides expressed by Liₓ[Li_{α}(MnₐCo_{b}M_{c})_{1-α}]O₂ (0.5<x<1.1, 0.1<α<0.33, 0.17<a<0.93, 0.03<b<0.50, 0.04<c<0.33, and M represents at least one type selected from the group consisting of Ni, Mg, Ti, Fe, Sn, Zr, Nb, Mo, W and Bi). Specific examples are Li_{0.744}[Li_{0.145}Mn_{0.625}Co_{0.115}Ni_{0.115}]O₂ and the like.

The content of the positive electrode active material with respect to the total mass of the positive electrode layer is preferably 65 mass %˜95 mass %, and more preferably 80 mass %˜90 mass %.

### (Conduction Assistant)

The positive electrode layer of the present disclosure may contain a conduction assistant. Examples of the conduction assistant are carbon-based materials such as artificial graphite, graphite carbon fibers, resin baked carbon, thermally decomposed vapor-grown carbon, coke, mesocarbon microbeads, furfuryl alcohol resin baked carbon, polyacene, pitch-based carbon fibers, vapor-grown carbon fibers, natural graphite, hard graphitized carbon and the like.

The content of the conduction assistant with respect to the total mass of the positive electrode layer is preferably 1 mass %˜5 mass %, and more preferably 1 mass %˜2 mass %.

### (Binder)

The positive electrode layer of the present disclosure may contain a binder. Examples of the binder are fluorine-based polymers such as polytetrafluoroethylene, polyvinylidene fluoride and the like, thermoplastic elastomers such as butylene rubber, styrene-butadiene rubber and the like, and various resins such as acrylic resins, acrylic polyol resins, polyvinyl acetal resins, polyvinyl butyral resins, silicone resins and the like.

The content of the binder with respect to the total mass of the positive electrode layer is preferably 0.1 mass %˜10 mass %, and more preferably 0.2 mass %˜0.8 mass %.

### (Other Components)

The positive electrode layer of the present disclosure may contain components (hereinafter called “other components”) other than the above-described components. Examples of the other components are solid electrolytes other than sulfide solid electrolytes, and the like.

Examples of solid electrolytes other than sulfide solid electrolytes are oxide solid electrolytes, halide solid electrolytes, and the like.

The oxide solid electrolyte preferably contains oxygen (O) as the main component of the anion elements, and, for example, may contain Li, element Q (Q represents at least one of Nb, B, Al, Si, P, Ti, Zr, Mo, W and S), and O. Examples of the oxide solid electrolyte are garnet type solid electrolytes, perovskite type solid electrolytes, NASICON type solid electrolytes, Li—P—O solid electrolytes, Li—B—O solid electrolytes, and the like. Examples of garnet type solid electrolytes are Li₇Lₐ₃Zr₂O₁₂, Li₇₋ₓLₐ₃(Zr₂₋ₓNbₓ)O₁₂ (0≤x≤2), Li₅La₃Nb₂O₁₂, and the like. Examples of perovskite type solid electrolytes are (Li,La)TiO₃, (Li,La)NbO₃, (Li,Sr)(Ta,Zr)O₃ and the like. Examples of NASICON type solid electrolytes are Li(Al,Ti)(PO₄)₃, Li(Al,Ga)(PO₄)₃, and the like. Examples of Li—P—O solid electrolytes are Li₃PO₄ and LIPON (compounds in which some of the O in Li₃PO₄ is substituted with N).

Examples of Li—B—O solid electrolytes are Li₃BO₃, compounds in which some of the O in Li₃BO₃ is substituted with C, and the like.

As the halide solid electrolyte, solid electrolytes containing Li, M and X (M represents at least one of Ti, Al and Y, and X represents F, Cl or Br) are suitable. Specifically, Li_{6-3z}Y_{z}X₆ (X represents Cl or Br, and z satisfies 0≤z≤2) and Li_{6-(4-x)b}(T₁₁₋ₓAlₓ)_{b}F₆ (0<x<1, 0<b≤1.5) are preferable. Among Li_{6-3z}Y_{z}X₆, from the standpoint of having excellent lithium ion conductivity, Li₃YX₆ (X represents Cl or Br) is more preferable, and Li₃YCl₆ is even more preferable. Further, from standpoints such as, for example, suppressing oxidative decomposition of the sulfide solid electrolyte and the like, it is preferable that Li_{6-(4-x)b}(T₁₁₋ₓAlₓ)_{b}F₆ (0<x<1, 0<b≤1.5) be contained together with a solid electrolyte such as a sulfide solid electrolyte or the like, and it is more preferable that Li_{6-(4-x)b}(T₁₁₋ₓAlₓ)_{b}F₆ (0<x<1, 0<b≤1.5) cover at least a portion of the surface of the solid electrolyte such as the sulfide solid electrolyte or the like. Due thereto, the lithium ion conductivity is even better.

### (Applications)

The positive electrode layer of the present disclosure can be suitably used as a material that structures the positive electrode of a solid-state battery.

### [Positive Electrode]

The positive electrode of the present disclosure has a positive electrode collector, and the above-described positive electrode layer that is formed on at least one surface of the positive electrode collector. Because the positive electrode layer has been described above, description thereof is omitted here.

### (Positive Electrode Collector)

A conventionally known positive electrode collector can be used as the positive electrode collector. Examples of the positive electrode collector are stainless steel, aluminum, nickel, iron, titanium, carbon and the like, and an aluminum alloy foil or an aluminum foil is preferable. The aluminum alloy foil and the aluminum foil may be manufactured by using a powder. The form of the positive electrode collector is, for example, the form of a foil or the form of a mesh.

The thickness of the positive electrode collector is not particularly limited, and can be made to be 1˜100 μm for example.

The thickness of the positive electrode layer is not particularly limited, and can be made to be 1˜200 μm for example.

The positive electrode of the present disclosure can be manufactured by coating an electrode composition which contains the specific sulfide solid electrolyte and the like on a surface of a positive electrode collector and drying it.

### (Applications)

The positive electrode of the present disclosure can be suitably used as the positive electrode of a solid-state battery.

### [Solid-State Battery]

The solid-state battery of the present disclosure has the positive electrode, an electrolyte layer, and a negative electrode.

Because the positive electrode has been described above, description thereof is omitted here.

The solid-state battery of the present disclosure is preferably a lithium ion battery.

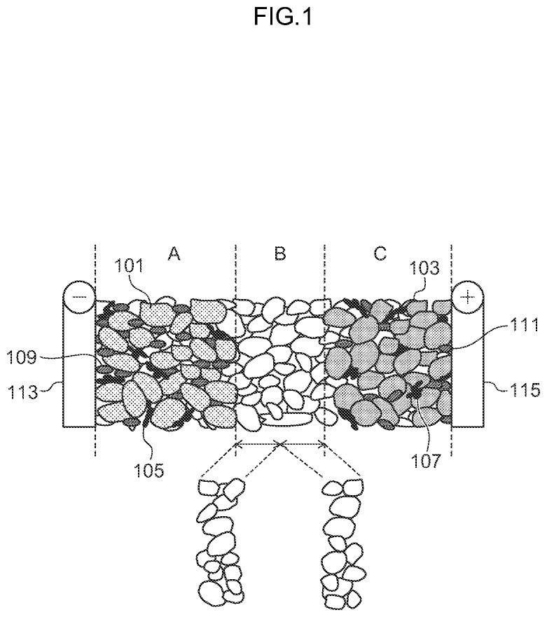

A schematic sectional view illustrating an embodiment of the solid-state battery is illustrated in FIG. 1. As illustrated in FIG. 1, a negative electrode layer A, an electrolyte layer B and a positive electrode layer C are layered.

In FIG. 1, a negative electrode active material is denoted by reference numeral 101, a positive electrode active material is denoted by reference numeral 103, conduction assistants are denoted by reference numerals 105 and 107, binders are denoted by reference numerals 109 and 111, a negative electrode collector is denoted by reference numeral 113, and a positive electrode collector is denoted by reference numeral 115.

The solid-state battery may have a structure in which the layer end surfaces (side surfaces) of a layered structure of a positive electrode/a solid electrolyte layer/a negative electrode are sealed by a resin. The positive electrode collector and the negative electrode collector may be a structure in which a shock-absorbing layer, an elastic layer or a PTC (Positive Temperature Coefficient) thermistor layer is disposed on the surface of the collector.

Further, the electrolyte layer may have a two-layer structure as illustrated in FIG. 1.

(Electrolyte Layer) The electrolyte layer contains a solid electrolyte. The solid electrolyte may be a single-layer structure, or may be a multilayer structure of two or more layers. Conventionally known solid electrolytes that can be used in the electrolyte layer of a solid-state battery can be used as the solid electrolyte, and sulfide solid electrolytes are an example thereof.

From the standpoint of decreasing the resistance increase rate of the solid-state battery, it is preferable that the electrolyte layer not contain a solid electrolyte having a covering layer that contains at least one of the specific compound and the specific polymer, or that the electrolyte layer contains a solid electrolyte having a covering layer containing at least one of the specific compound and the specific polymer, and the content of the solid electrolyte, which has a covering layer containing at least one of the specific compound and the specific polymer, with respect to the total mass of the electrolyte layer is less than or equal to 1 mass %, and it is more preferable that the electrolyte layer not contain a solid electrolyte having a covering layer that contains at least one of the specific compound and the specific polymer, or that the electrolyte layer contains a solid electrolyte having a covering layer containing at least one of the specific compound and the specific polymer, and the content of the solid electrolyte, which has a covering layer containing at least one of the specific compound and the specific polymer, with respect to the total mass of the electrolyte layer is less than or equal to 0.5 mass %, and it is even more preferable that the electrolyte layer not contain a solid electrolyte having a covering layer that contains at least one of the specific compound and the specific polymer, or that the electrolyte layer contains a solid electrolyte having a covering layer containing at least one of the specific compound and the specific polymer, and the content of the solid electrolyte, which has a covering layer containing at least one of the specific compound and the specific polymer, with respect to the total mass of the electrolyte layer is less than or equal to 0.1 mass %, and it is particularly preferable that the electrolyte layer not contain a solid electrolyte having a covering layer that contains at least one of the specific compound and the specific polymer.

The electrolyte layer may contain a binder. Examples of the binder are rubber binders such as styrene-butadiene rubber and the like, fluorine binders such as polyvinylidene fluoride (PVDF) and the like, and the like.

An electrolyte layer that has been manufactured by a conventionally known method or a commercially-available electrolyte layer may be used as the electrolyte layer.

The thickness of the electrolyte layer is not particularly limited, and can be made to be 1 μm˜100 μm for example.

### (Negative Electrode)

The negative electrode has a negative electrode collector, and the above-described negative electrode layer formed on at least one surface of the negative electrode collector.

### —Negative Electrode Collector—

The negative electrode collector can use the above-described metal foils, and a nickel foil is preferable.

The thickness of the negative electrode collector is not particularly limited, and can be made to be 10 μm˜100 μm for example.

### —Negative Electrode Layer—

The negative electrode layer can contain a solid electrolyte. Conventionally known solid electrolytes that can be used in the negative electrode layer of a solid-state battery can be used as the solid electrolyte, and sulfide solid electrolytes are an example thereof.

From the standpoint of decreasing the resistance increase rate of the solid-state battery, it is preferable that the negative electrode layer not contain a solid electrolyte having a covering layer that contains at least one of the specific compound and the specific polymer, or that the negative electrode layer contains a solid electrolyte having a covering layer containing at least one of the specific compound and the specific polymer, and the content of the solid electrolyte, which has a covering layer containing at least one of the specific compound and the specific polymer, with respect to the total mass of the negative electrode layer is less than or equal to 1 mass %, and it is more preferable that the negative electrode layer not contain a solid electrolyte having a covering layer that contains at least one of the specific compound and the specific polymer, or that the negative electrode layer contains a solid electrolyte having a covering layer containing at least one of the specific compound and the specific polymer, and the content of the solid electrolyte, which has a covering layer containing at least one of the specific compound and the specific polymer, with respect to the total mass of the negative electrode layer is less than or equal to 0.5 mass %, and it is even more preferable that the negative electrode layer not contain a solid electrolyte having a covering layer that contains at least one of the specific compound and the specific polymer, or that the negative electrode layer contains a solid electrolyte having a covering layer containing at least one of the specific compound and the specific polymer, and the content of the solid electrolyte, which has a covering layer containing at least one of the specific compound and the specific polymer, with respect to the total mass of the negative electrode layer is less than or equal to 0.1 mass %, and it is particularly preferable that the negative electrode layer not contain a solid electrolyte having a covering layer that contains at least one of the specific compound and the specific polymer.

The negative electrode layer can contain a negative electrode active material. Examples of the negative electrode active material are silicon, silicon alloys, silicon oxides and the like. Further, metallic lithium or metals that can form alloys with metallic lithium such as metallic indium, metallic aluminum, metallic silicon, metallic tin and the like, and oxides of these metals, and alloys of these metals and metallic lithium, and the like may be used as the negative electrode active material.

The content of the negative electrode active material with respect to the total mass of the negative electrode layer is not particularly limited and can be 40 mass %˜75 mass % for example.

The thickness of the negative electrode layer is not particularly limited, and can be made to be 1 μm˜100 μm for example.

The negative electrode layer may contain the above-described conduction assistants, binders and the like.

A negative electrode that has been manufactured by a conventionally known method or a commercially-available negative electrode may be used as the negative electrode.

### EXAMPLES

The present disclosure is described in further detail hereinafter by way of Examples, but the invention of the present disclosure is not limited to these Examples.

### Example 1

(Formation of Positive Electrode Layer and Fabrication of Positive Electrode) In a nitrogen atmosphere, 0.59 g of lithium sulfide, 0.95 g of diphosphorus pentasulfide, 0.19 g of lithium bromide and 0.28 g of lithium iodide were introduced into a Schlenk flask equipped with a stirrer (volume: 100 mL). After the stirrer was rotated, 20 mL of tetramethylethylenediamine (TMEDA) that is a complexing agent was added, and stirring was continued for 12 hours. The obtained complex-containing substance was dried in a vacuum (room temperature: 23° C.), and a complex that was a powder was obtained. Then, heating of the complex powder at 120° C. was carried out in a vacuum for 2 hours, and a non-crystalline sulfide solid electrolyte was obtained. Further, heating of the non-crystalline sulfide solid electrolyte at 140° C. was carried out in a vacuum for 2 hours, and crystalline sulfide solid electrolyte A was obtained. (The heating temperature for obtaining the crystalline sulfide solid electrolyte (140° C. in the present Example) is called the “crystallization temperature” upon occasion.)

In a nitrogen atmosphere, 3 g of the crystalline sulfide solid electrolyte A that was obtained as described above was weighed-out and added to a Schlenk flask equipped with a stirrer (volume: 100 mL), 22 g of toluene was added thereto, stirring was carried out, and a slurry-like fluid was obtained. The compound listed in Table 1 as the specific compound was further added to the slurry-like fluid in an amount so as to become a proportion of 0.16 g (5 parts by mass with respect to 100 parts by mass of the crystalline sulfide solid electrolyte), and after stirring for 10 minutes, the toluene was distilled off by vacuum drying, and the specific sulfide solid electrolyte A having a covering layer on a surface thereof was obtained. The specific sulfide solid electrolyte A was observed by a scanning electron microscope with EDS (SEM-EDS, magnification 30,000X), and thereafter, the Si derived from the polysiloxane was mapped by EDS, and image analysis was carried out by ImageJ. It was thereby confirmed that the specific sulfide solid electrolyte A had a covering layer. Further, it was confirmed by GC-MS that the covering layer contained a polymer of the above-described specific compound. These were confirmed by the same methods in the following Examples and Comparative Examples as well.

80.0 g of (LiNi1/3Col/3Mn1/3O₂) as a positive electrode active material, 9.51 g of the specific sulfide solid electrolyte that was obtained as described above, and 2.5 g of carbon fibers (VGCF manufactured by Showa Denko K.K.) serving as a conduction assistant were collected in a FILMIX. Thereafter, a solution containing styrene-butadiene rubber that is a binder (the concentration of the binder in the solution was 5 mass % with respect to the entire solution), and 32.21 g of tetralin that is a solvent were added into the FILMIX, and a raw material composition for a positive electrode whose solids concentration was 69 mass % was obtained. The FILMIX was used as a kneading device, and the raw material composition for a positive electrode was kneaded at a peripheral speed of 25 m/s, and an electrode composition for a positive electrode was obtained. A high shear PC wheel was used at the FILMIX. The electrode composition for a positive electrode was coated in the form of a film onto the surface of a positive electrode collector (aluminum foil) by a blade coating method using an applicator, and the film-like electrode composition was heated at 100° C. for 30 minutes, and a positive electrode layer was formed on the surface of the positive electrode collector. A positive electrode having a positive electrode collector and a positive electrode layer was thereby obtained.

### (Formation of Negative Electrode Layer and Fabrication of Negative Electrode)

18.6 g of elemental Si serving as a negative electrode active material, 8.69 g of sulfide solid electrolyte A, a solution containing styrene-butadiene rubber that is a binder (the concentration of the binder in the solution was 5 mass % with respect to the entire solution), and diisobutylketone that is a solvent were added into a FILMIX, and a raw material composition for a negative electrode whose solids concentration was 43 mass % was obtained. The FILMIX was used as a kneading device, and the raw material composition for a negative electrode was kneaded at a peripheral speed in a range of 5 m/s˜30 m/s, and an electrode composition for a negative electrode was obtained. A high shear PC wheel was used at the FILMIX. The electrode composition for a negative electrode was coated in the form of a film onto the surface of a negative electrode collector (nickel foil) by a blade coating method using an applicator, and the film-like electrode composition was heated at 100° C. for 30 minutes, and a negative electrode layer was formed on the surface of the negative electrode collector. A negative electrode having a negative electrode collector and a negative electrode layer was thereby obtained.

### (Fabrication of Solid Electrolyte Layer)

40 g of sulfide solid electrolyte A, 8.00 g of a solution containing acrylate-butadiene rubber and hexane (the concentration of the acrylate-butadiene rubber in the solution was 5 mass % with respect to the entire solution), 25.62 g of heptane, and 8.00 g of dibutyl ether were mixed together, and were kneaded by an ultrasonic homogenizer, and a solid electrolyte layer composition was obtained. The solid electrolyte layer composition was coated in the form of a film onto the surface of an aluminum foil by a blade coating method using an applicator, and the film-like solid electrolyte layer composition was heated at 100° C. for 30 minutes, and a solid electrolyte layer was formed.

### (Manufacture of Solid-State Battery)

The solid electrolyte layer and the positive electrode were transferred onto the both surfaces of the obtained negative electrode in that order by using pressure of 20 kN. The obtained layered body was pressed by using a roll press, and a solid-state battery was obtained. The press linear pressure was 4 ton/cm. The gap between the rollers was 200 μm.

### Example 2 and Example 3

A solid-state battery was manufactured in the same way as in Example 1, except that the specific compound was changed to the specific compound listed in Table 1.

Note that the specific sulfide solid electrolyte used in Example 2 was specific sulfide solid electrolyte B, and the specific sulfide solid electrolyte used in Example 3 was specific sulfide solid electrolyte C.

### Comparative Example 1˜Comparative Example 3

### (Formation of Positive Electrode Layer and Fabrication of Positive Electrode)

A positive electrode was fabricated in the same way as in Example 1, except that the specific sulfide solid electrolyte A was changed to sulfide solid electrolyte A that did not have a covering layer.

### (Formation of Negative Electrode Layer and Fabrication of Negative Electrode)

A negative electrode was fabricated in the same way as in Example 1, except that the sulfide solid electrolyte A that did not have a covering layer was changed to the specific sulfide solid electrolyte listed in Table 1.

### (Fabrication of Solid Electrolyte Layer and Manufacture of Solid-State Battery)

In the same way as in Example 1, a solid electrolyte layer was fabricated, and a solid-state battery was manufactured.

### Comparative Example 4˜Comparative Example 6

### (Formation of Positive Electrode Layer and Fabrication of Positive Electrode)

A positive electrode was fabricated in the same way as in Example 1, except that the specific sulfide solid electrolyte A was changed to sulfide solid electrolyte A that did not have a covering layer.

### (Formation of Negative Electrode Layer and Fabrication of Negative Electrode)

A negative electrode was fabricated in the same way as in Example 1.

### (Fabrication of Solid Electrolyte Layer)

A solid electrolyte layer was fabricated in the same way as in Example 1, except that the sulfide solid electrolyte A that did not have a covering layer was changed to the specific sulfide solid electrolyte listed in Table 1.

### (Manufacture of Solid-State Battery)

A solid-state battery was manufactured in the same way as in Example 1.

### Comparative Example 7

### (Formation of Positive Electrode Layer and Fabrication of Positive Electrode)

A positive electrode was fabricated in the same way as in Example 1, except that the specific sulfide solid electrolyte A was changed to sulfide solid electrolyte A that did not have a covering layer.

### (Formation of Negative Electrode Layer and Fabrication of Negative Electrode)

A negative electrode was fabricated in the same way as in Example 1.

### (Fabrication of Solid Electrolyte Layer)

A solid electrolyte layer was fabricated in the same way as in Example 1.

### (Manufacture of Solid-State Battery)

A solid-state battery was manufactured in the same way as in Example 1.

### Comparative Example 8˜Comparative Example 9

### (Formation of Positive Electrode Layer and Fabrication of Positive Electrode)

A solid-state battery was manufactured in the same way as in Example 1, except that the compound used in the covering layer of the sulfide solid electrolyte was changed to the compound listed in Table 1.

Note that the sulfide solid electrolytes used in Comparative Example 8 and Comparative Example 9 had covering layers, but the compounds contained therein were not the specific compounds.

Further, the sulfide solid electrolyte used in Comparative Example 8 was sulfide solid electrolyte x, and the sulfide solid electrolyte used in Comparative Example 9 was sulfide solid electrolyte y.

### (Formation of Negative Electrode Layer and Fabrication of Negative Electrode)

A negative electrode was fabricated in the same way as in Example 1.

### (Fabrication of Solid Electrolyte Layer)

A solid electrolyte layer was fabricated in the same way as in Example 1.

### (Manufacture of Solid-State Battery)

A solid-state battery was manufactured in the same way as in Example 1.

### Comparative Example 10˜Comparative Example 11

### (Formation of Positive Electrode Layer and Fabrication of Positive Electrode)

A positive electrode was fabricated in the same way as in Example 1, except that the specific sulfide solid electrolyte A was changed to sulfide solid electrolyte A that did not have a covering layer.

### (Formation of Negative Electrode Layer and Fabrication of Negative Electrode)

A negative electrode was fabricated in the same way as in Example 1, except that the sulfide solid electrolyte A that did not have a covering layer was changed to the sulfide solid electrolyte listed in Table 1.

### (Fabrication of Solid Electrolyte Layer and Manufacture of Solid-State Battery)

In the same way as in Example 1, a solid electrolyte layer was fabricated, and a solid-state battery was manufactured.

### Comparative Example 12˜Comparative Example 13

### (Formation of Positive Electrode Layer and Fabrication of Positive Electrode)

A positive electrode was fabricated in the same way as in Example 1, except that the specific sulfide solid electrolyte A was changed to sulfide solid electrolyte A that did not have a covering layer.

### (Formation of Negative Electrode Layer and Fabrication of Negative Electrode)

A negative electrode was fabricated in the same way as in Example 1.

### (Fabrication of Solid Electrolyte Layer)

A solid electrolyte layer was fabricated in the same way as in Example 1, except that the sulfide solid electrolyte A that did not have a covering layer was changed to the sulfide solid electrolyte listed in Table 1.

### (Manufacture of Solid-State Battery)

A solid-state battery was manufactured in the same way as in Example 1.

### [Evaluation of Resistance Increase Rate]

By using the solid-state batteries obtained in the Examples and the Comparative Examples, CCCV charging/discharging of a maximum voltage of 4.55 V and a minimum voltage of 2.5 V was carried out over 1000 cycles at 0.1 C. The design capacity of the solid-state battery was 0.3 Ah. The battery resistance increase rates were calculated from the obtained results on the basis of the following formula, and are shown in Table 1. Note that the initial resistance is the resistance after 3 cycles.

resistance increase rate (%)=((battery resistance after 1000cycles−initial resistance)/initial resistance)×100

TABLE 1

| | Compound used | Sulfide solid electrolyte that is used | | | | Resistance | Resistance |
|---|---|---|---|---|---|---|---|
| | in covering | Positive | Negative | Solid | Initial | (Ω · cm²) | increase |
| | layer of sulfide | electrode | electrode | electrolyte | resistance | after 1000 | rate |
| | solid electrolyte | layer | layer | layer | (Ω · cm²) | cycles | (%) |
| Example 1 | 1,1,1,3,5,5,5- | specific sulfide | sulfide solid | sulfide solid | 110 | 300 | 173 |
| | Heptamethyl-3-(3- | solid electrolyte | electrolyte A | electrolyte A | | | |
| | glycidyloxypropyl) | A | | | | | |
| | trisiloxane | | | | | | |
| Example 2 | 2-Ethylhexyl Glycidyl | specific sulfide | sulfide solid | sulfide solid | 110 | 324 | 195 |
| | Ether | solid electrolyte | electrolyte A | electrolyte A | | | |
| | | B | | | | | |
| Example 3 | 4-tert-Butylphenyl | specific sulfide | sulfide solid | sulfide solid | 95 | 262 | 176 |
| | Glycidyl Ether | solid electrolyte | electrolyte A | electrolyte A | | | |
| | | C | | | | | |
| Comparative | 1,1,1,3,5,5,5- | sulfide solid | specific sulfide | sulfide solid | 173 | 723 | 318 |
| Example 1 | Heptamethyl-3-(3- | electrolyte A | solid electrolyte | electrolyte A | | | |
| | glycidyloxypropyl) | | A | | | | |
| | trisiloxane | | | | | | |
| Comparative | 2-Ethylhexyl Glycidyl | sulfide solid | specific sulfide | sulfide solid | 175 | 726 | 315 |
| Example 2 | Ether | electrolyte A | solid electrolyte | electrolyte A | | | |
| | | | B | | | | |
| Comparative | 4-tert-Butylphenyl | sulfide solid | specific sulfide | sulfide solid | 171 | 732 | 328 |
| Example 3 | Glycidyl Ether | electrolyte A | solid electrolyte | electrolyte A | | | |
| | | | C | | | | |
| Comparative | 1,1,1,3,5,5,5- | sulfide solid | sulfide solid | specific sulfide | 152 | 612 | 303 |
| Example 4 | Heptamethyl-3-(3- | electrolyte A | electrolyte A | solid electrolyte | | | |
| | glycidyloxypropyl) | | | A | | | |
| | trisiloxane | | | | | | |
| Comparative | 2-Ethylhexyl Glycidyl | sulfide solid | sulfide solid | specific sulfide | 151 | 615 | 307 |
| Example 5 | Ether | electrolyte A | electrolyte A | solid electrolyte | | | |
| | | | | B | | | |
| Comparative | 4-tert-Butylphenyl | sulfide solid | sulfide solid | specific sulfide | 155 | 614 | 296 |
| Example 6 | Glycidyl Ether | electrolyte A | electrolyte A | solid electrolyte | | | |
| | | | | C | | | |
| Comparative | — | sulfide solid | sulfide solid | sulfide solid | 148 | 523 | 253 |
| Example 7 | | electrolyte A | electrolyte A | electrolyte A | | | |
| Comparative | 1,2-Epoxyoctadecane | sulfide solid | sulfide solid | sulfide solid | 130 | 562 | 332 |
| Example 8 | | electrolyte x | electrolyte A | electrolyte A | | | |
| Comparative | Bisphenol A Diglycidyl | sulfide solid | sulfide solid | sulfide solid | 113 | 487 | 331 |
| Example 9 | Ether | electrolyte y | electrolyte A | electrolyte A | | | |
| Comparative | 1,2-Epoxyoctadecane | sulfide solid | sulfide solid | sulfide solid | 192 | 825 | 330 |
| Example 10 | | electrolyte A | electrolyte x | electrolyte A | | | |
| Comparative | Bisphenol A Diglycidyl | sulfide solid | sulfide solid | sulfide solid | 201 | 812 | 304 |
| Example 11 | Ether | electrolyte A | electrolyte y | electrolyte A | | | |
| Comparative | 1,2-Epoxyoctadecane | sulfide solid | sulfide solid | sulfide solid | 181 | 734 | 306 |
| Example 12 | | electrolyte A | electrolyte A | electrolyte x | | | |
| Comparative | Bisphenol A Diglycidyl | sulfide solid | sulfide solid | sulfide solid | 172 | 712 | 314 |
| Example 13 | Ether | electrolyte A | electrolyte A | electrolyte y | | | |

From the results of Table 1, it can be understood that, as compared with the solid-state batteries of the Comparative Examples, the resistance increase rate was reduced in the solid-state batteries of the Examples in which a specific sulfide solid electrolyte was contained in the positive electrode layer.

### EXPLANATION OF REFERENCE NUMERALS

A: negative electrode layer, B: electrolyte layer, C: positive electrode layer, 101: negative electrode active material, 103: positive electrode active material, 105 and 107: conduction assistant, 109 and 111: binder, 113: negative electrode collector, 115: positive electrode collector

What is claimed is:

1. A positive electrode layer, comprising a sulfide solid electrolyte containing a lithium atom, a sulfur atom and a halogen atom,
wherein the sulfide solid electrolyte has, on a surface thereof, a covering layer containing at least one selected from compounds represented by the following general formula (1), compounds represented by the following general formula (2), polymers of compounds represented by the following general formula (1), polymers of compounds represented by the following general formula (2), or polymers of a compound represented by the following general formula (1) and a compound represented by the following general formula (2): 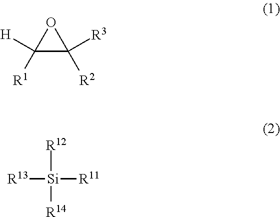
wherein, in formula (1), each of R¹ to R³ independently represents a hydrogen atom, a halogen atom, a monovalent hydrocarbon group or a monovalent halogenated hydrocarbon group, at least one of R¹ to R³ is a monovalent hydrocarbon group or a monovalent halogenated hydrocarbon group, and at least one of R¹ to R³ has an ether structure; and
wherein, in formula (2), each of R¹¹ to R¹⁴ independently represents a hydrogen atom, a halogen atom, a monovalent silyl ether group, a monovalent hydrocarbon group or a monovalent halogenated hydrocarbon group, and at least one of R¹¹ to R¹⁴ is a silyl ether group.

2. The positive electrode layer of claim 1, wherein:
the covering layer contains at least one of a compound represented by general formula (1) or a polymer of a compound represented by general formula (1), and
any two among R¹ to R³ are hydrogen atoms, and one is a monovalent hydrocarbon group having an ether structure.

3. The positive electrode layer of claim 1, wherein:
the covering layer contains at least one of a compound represented by general formula (2) or a polymer of a compound represented by general formula (2), and
among R¹¹ to R¹⁴, three are monovalent silyl ether groups, and one is a monovalent hydrocarbon group.

4. The positive electrode layer of claim 1, wherein the covering layer contains at least one selected from compounds represented by the following chemical formulae, or polymers containing at least one compound represented by the following chemical formulae:

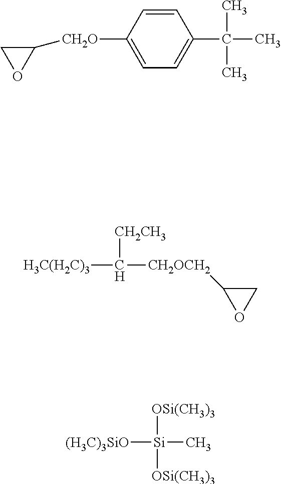

5. The positive electrode layer of claim 1, wherein a molecular weight or weight average molecular weight of a compound represented by general formula (1), a compound represented by general formula (2), a polymer of a compound represented by general formula (1), a polymer of a compound represented by general formula (2), and a polymer of a compound represented by general formula (1) and a compound represented by general formula (2), is 60 or more.

6. The positive electrode layer of claim 1, wherein, given that a content of the sulfide solid electrolyte contained in the positive electrode layer is 100 parts by mass, a sum of contents of a compound represented by general formula (1), a compound represented by general formula (2), a polymer of a compound represented by general formula (1), a polymer of a compound represented by general formula (2), and a polymer of a compound represented by general formula (1) and a compound represented by general formula (2), is from 0.1 parts by mass to 20 parts by mass.

7. A positive electrode, comprising a positive electrode collector and the positive electrode layer of claim 1.

8. A solid-state battery, comprising the positive electrode of claim 7, an electrolyte layer, and a negative electrode having a negative electrode layer and a negative electrode collector.

9. The solid-state battery of claim 8, wherein:
the electrolyte layer does not contain a solid electrolyte having, on a surface, a covering layer that contains at least one selected from compounds represented by the following general formula (1), compounds represented by the following general formula (2), polymers of compounds represented by the following general formula (1), polymers of compounds represented by the following general formula (2), and polymers of a compound represented by the following general formula (1) and a compound represented by the following general formula (2), or the electrolyte layer contains a solid electrolyte having the covering layer, and a content of the solid electrolyte having the covering layer, with respect to a total mass of the electrolyte layer, is less than or equal to 1 mass %, and
the negative electrode layer does not contain a solid electrolyte having, on a surface, a covering layer that contains at least one selected from compounds represented by the following general formula (1), compounds represented by the following general formula (2), polymers of compounds represented by the following general formula (1), polymers of compounds represented by the following general formula (2), and polymers of a compound represented by the following general formula (1) and a compound represented by the following general formula (2), or the negative electrode layer contains a solid electrolyte having the covering layer, and a content of the solid electrolyte having the covering layer, with respect to a total mass of the negative electrode layer, is less than or equal to 1 mass %: 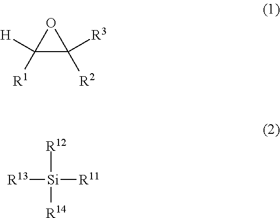
wherein, in formula (1), each of R¹ to R³ independently represents a hydrogen atom, a halogen atom, a monovalent hydrocarbon group or a monovalent halogenated hydrocarbon group, at least one of R¹ to R³ is a monovalent hydrocarbon group or a monovalent halogenated hydrocarbon group, and at least one of R¹ to R³ has an ether structure; and
wherein, in formula (2), each of R¹¹ to R¹⁴ independently represents a hydrogen atom, a halogen atom, a monovalent silyl ether group, a monovalent hydrocarbon group or a monovalent halogenated hydrocarbon group, and at least one of R¹¹ to R¹⁴ is a silyl ether group.
